(19) United States
(12) Patent Application Publication
(10) Pub. No.: US 2022/0180286 A1
(43) Pub. Date: Jun. 9, 2022

(54) Method and Device for Automatically Identifying a Product Error in a Product and/or for Automatically Identifying a Product Error Cause of the Product Error

(71) Applicant: ZF Friedrichshafen AG, Friedrichshafen (DE)

(72) Inventors: Mazlum Zerey, Saarbrücken (DE); Christoph Kirst, Wadgassen (DE); Emile Nomine, Epping (FR); Kevin Thomas, Saarbrücken (DE); Minjia Chang, Tettnang (DE); Stefan Jochem, Voelklingen (DE)

(21) Appl. No.: 17/429,021

(22) PCT Filed: Feb. 5, 2020
(86) PCT No.: PCT/EP2020/052786

§ 371 Date: Aug. 6, 2021

(30) Foreign Application Priority Data
Feb. 7, 2019 (DE) 10 2019 201 557.3

(51) Int. Cl. G06Q 10/06

(52) U.S. Cl. CPC G06Q 10/06395

(57) ABSTRACT

A method for the automated identification of a product defect of a product and/or for the automated identification of a product defect cause of the product defect, includes producing the product from a plurality of product elements via a plurality of manufacturing steps, and gathering a number n of items of test information by at least one product test, wherein the n items of test information form an n-dimensional test value. The method also includes carrying out a dimension reduction of the n-dimensional test value by at least one statistics process to obtain a dimension-reduced test value, comparing the dimension-reduced test value with a multitude of learned reference values, assigning the dimension-reduced test value to at least one group of reference values that are similar to each other, and identifying, in an automated manner, the product defect and/or the product defect cause on the basis of the assignment.

### CROSS-REFERENCE TO RELATED APPLICATIONS

The present application is related and has right of priority to German Patent Application No. 102019201557.3 filed in the German Patent Office on Feb. 7, 2019 and is a nationalization of PCT/EP2020/052786 filed in the European Patent Office on Feb. 5, 2020, both of which are incorporated by reference in their entirety for all purposes.

### FIELD OF THE INVENTION

The present invention relates generally to a method for the automated identification of a product defect of a product and/or for the automated identification of a product defect cause of the product defect and to a device for the automated identification of a product defect cause of the product defect.

### BACKGROUND

From the prior art it is known to gather and statistically process a plurality of different measured data regarding the condition of the products, on the one hand, already during the manufacture of complex products and, on the other hand, also after the completion of the complex products. The data processed in this way are then compared to specified values, in order to identify defective products. The defective products can be subsequently subjected to a defect analysis, in order to identify the specific product defect and, if possible, also the product defect cause underlying the product defect. On the basis of the identified product defect, a suitable repair measure for the product can then be initiated, if necessary. Provided it is possible to also identify the product defect cause, additionally, it can be attempted to improve the manufacturing process and/or to configure the manufacturing process to be as error-free as possible.

DE 43 05 522 A1 describes, in this context, a device for the computer-aided diagnosis of a technical system made up of different modules. The device includes, in a first memory, information regarding the technical system, regarding its malfunctions, and regarding its diagnostic options. The configuration of the technical system is stored in a second memory. A third memory contains a knowledge module for the technical system, wherein the knowledge module is generated from the information of the first memory and of the second memory, adapted to the technical system manufactured from specific modules.

DE 195 07 134 C1 discloses a method for the automatic derivation of process- and product-related knowledge from an integrated product and process model. The method includes modeling a configuration and function structure of products and processes in an integrated model, which represents the relationship between the product and its development process. In addition, the method includes modeling defect knowledge, modeling structures for the modularization of the knowledge modules, and modeling structures for the generalization of the knowledge modules. Finally, the method derives knowledge regarding a predefined context on the basis of the knowledge modules.

The known methods and devices are disadvantageous, however, in that the known methods and devices do not allow for a fully automated identification of product defects and defect causes in complex products, such as, for example, vehicle transmissions, due to the multitude of parts, the multitude of manufacturing steps, some of which are carried out by different suppliers in different ways and result in different intermediate product properties, and due to the multitude of assembly steps of the intermediate products resulting in the overall product.

### SUMMARY OF THE INVENTION

Example aspects of the invention is provide an improved method for the automated identification of a product defect of a product and/or for the automated identification of a product defect cause of the product defect.

Example aspects of the invention relate to a method for the automated identification of a product defect of a product and/or for the automated identification of a product defect cause of the product defect, including
producing the product from a multitude of product elements by a multitude of manufacturing steps, and
gathering a number n of items of test information by at least one product test, wherein the n items of test information form an n-dimensional test value.

The method according to example aspects of the invention is distinguished by
carrying out a dimension reduction of the n-dimensional test value by at least one statistics process to obtain a dimension-reduced test value,
comparing the dimension-reduced test value to a multitude of learned reference values,
assigning the dimension-reduced test value to at least one group of reference values that are similar to each other, and
identifying, in an automated manner, the product defect and/or the product defect cause on the basis of the assignment.

Example aspects of the invention therefore describe a method, which allows for an automated identification of a product defect of the product and/or a product defect cause of the product defect on the basis of gathered items of test information. The product itself can also be designed in a comparatively complex manner and be made up of a multitude of individual product elements, which were assembled in a multitude of manufacturing steps to form the finished product. For example, the product can be a vehicle transmission, which is made up of several hundred individual product elements, wherein the product elements are assembled and/or machined in a multitude of manufacturing steps at one or several manufacturing stations or production lines. Advantageously, all items of test information that describe a certain property of the product are handled as an n-dimensional test value. This means, a separate n-dimensional test value is generated for each tested property of the product. Alternatively, it is preferred when all items of test information that describe several or all properties of the product are handled as a single n-dimensional test value. The n-dimensional test value can therefore equally describe only one specific property, for example, an acoustic behavior, as well as several or all properties of the product. Since the value n, which designates the dimension number, can have values considerably greater than 10⁶ due to the multitude of gathered items of test information, a dimension reduction is still carried out. Common statistics processes for dimension reduction are known from the prior art, in particular from the area of descriptive statistics. A statistics process of this type, which is preferred within the scope of the invention, is t-distributed stochastic neighbor embedding (or t-SNE), which also takes comparatively complex data relationships into account. Due to the comparison of the dimension-reduced test value with the multitude of learned reference values, an assignment of the test value to a group of reference values that are also similar to each other can then take place, for example, on the basis of similarities of the test value with the reference values. Each group of reference values corresponds to one or several product defects and/or product defect causes. A further group corresponds to a defect-free product. For example, a group of reference values can correspond to the “product defect X, caused by product defect cause Y”. The successful assignment of the test value to such a group of reference values then makes it possible to identify the particular underlying product defect and/or the particular underlying product defect cause. The dimension reduction of the test value and/or of the reference values results, namely, in a group formation of test values and/or reference values, which have a similarity among one another in the sense of an identical or similar product defect as well as an identical or similar product defect cause. Therefore, an identification of the product defect and/or the product defect cause can take place via the assignment to one of these groups of reference values.

The method according to example aspects of the invention therefore yields the advantage that a complete or at least largely complete inspection of a complex product for product defects is made possible in a comparatively easy way and, in particular, in an automated manner. This, in turn, allows for simple or, possibly, even automatic decision-making regarding how to proceed with the defective product, whether a repair, if necessary, is possible and makes economic sense, or whether the defective product must be disposed of. Simultaneously, the product defect cause underlying the particular detected product defect can also be ascertained in an automated manner, and so a check of the appropriate manufacturing step can also take place here in a comparatively easy way and, in particular, in an automated manner, in particular for the case in which the underlying product defect arises frequently.

According to one preferred example embodiment of the invention, the multitude of reference values is classified according to product defects and/or product defect causes during a learning process. This means, particular specific product defects and/or product defect causes are assigned to the reference values. Via the comparison of the test value with the reference values and the product defects and/or product defect causes assigned thereto, product defects and/or product defect causes can then be inferred, for example, on the basis of a similarity of the test value to one or several reference value(s), in particular to a group of reference values.

The classification of the reference values according to product defects and/or product defect causes preferably takes place manually by a human operator, in that defective products are manually inspected with regard to their specific product defects and, provided these are ascertainable, the product defect causes. These detected product defects and/or product defect causes can then be manually assigned to the items of test information and, thereby, to the test values of these products. Thereafter, the test values classified in this way are utilized as reference values for the method according to example aspects of the invention.

It is also possible and preferred that a reference value describes more than only one product defect, since more than only one product defect can simultaneously arise at the product. Provided that an unambiguous identification of a specific product defect is not possible, a probability that the specific product defect and/or a number of further possible product defects is/are present can also be indicated. This is the case, for example, when the dimension-reduced test value can be assigned to more than only one group of reference values, optionally under consideration of tolerances.

A possible product defect cause can also be associated with a certain probability, provided that an identification of the specific product defect is not unambiguously possible.

According to a further preferred example embodiment of the invention, the assignment takes place in accordance with a distance matrix. The distance matrix shows distances between the test value and different reference values and/or the different groups of reference values. Depending on how great the distances of the test value are to the different reference values and/or the different groups of reference values, a greater or lesser similarity of the test value to the appropriate reference values and/or to the appropriate groups of reference values can be established. The distance matrix can also include certain tolerances, within which a certain extent of similarity is established. This makes it possible to reliably assign the test value also in the case of only low similarities.

According to a further preferred example embodiment of the invention, the reference values are dimension-reduced by at least one statistics process to a dimension number that is identical to that of the dimension-reduced test value. This yields the advantage that, due to the identical dimension number, an optimal comparability of the test value to the reference values and/or to the groups of reference values is given.

Preferably, the identical statistics process is utilized for the dimension reduction of the reference values as for the dimension reduction of the test value. This also results in a largely optimal comparability of the test value with the reference values and/or the group of reference values.

It is further preferred that the reference values are already dimension-reduced by the statistics process as the reference values are learned or are even dimension-reduced by the statistics process before the reference values are learned.

According to a further preferred example embodiment of the invention, the dimension-reduced test value has at least one hundred (100) dimensions. This value of the dimensionality has been proven, in practical application, to be a good compromise between the diversity of information of the items of test information, on the one hand, and the computing power-related manageability, on the other hand.

In particular, the dimension-reduced test value has at least three hundred (300) dimensions. Although this makes it necessary to revert to comparatively powerful processors, it also simultaneously allows for a comparatively diverse and detailed comparison with the reference values and/or the groups of reference values, which permits a comparatively exact and reliable identification of the highly diverse product defects and product defect causes.

Alternatively, it is preferably provided that the dimension-reduced test value has precisely two (2) dimensions. This allows for the graphical representation on a conventional monitor and/or any conventional, two-dimensional display for a human operator. Due to the utilization of suitable statistics processes, a reliable and, primarily, significant comparison of the two-dimensional test value with the groups of reference values can nevertheless be made possible. A reliable formation of groups of the reference values is also made possible. It is to be emphasized once more that the items of information of the dimensions extending beyond the second dimension are not deleted or will not be not taken into consideration due to the fact that the test value and, preferably, also the reference values are reduced to two dimensions, but rather that the properties of all these dimensions are projected onto the remaining two dimensions, and are also reflected in the two-dimensional representation of the test value and, advantageously, also of the reference values.

According to a further preferred example embodiment of the invention, an assignability of the multitude of product elements to the product and/or a traceability of the product across all manufacturing steps is made available. An assignability of the product to the multitude of product elements is understood, within the meaning of the invention, to mean that it remains possible to trace, also after the completion of the product, which individual product elements were utilized for manufacturing the product and are now integral parts of the product. This can take place, for example, by appropriate documentation and requires that each product element has been appropriately individually marked. For example, the product elements can be gearwheels, which were assembled within the scope of production to form a vehicle transmission, the product. Due to the fact that an assignability of the individual gearwheels to the vehicle transmission is now provided, it remains possible to trace, also after the completion of the transmission, which gearwheels from which lot and from which supplier were installed at which point of the transmission. A traceability of the product across all manufacturing steps is understood, within the meaning of the invention, to mean that it remains possible to trace, also after the completion of the product, which individual manufacturing stations have carried out which manufacturing steps, and when, on the product. This can also take place, for example, by appropriate documentation, wherein a precondition therefor is an appropriate individual marking of the product. In order to remain with the aforementioned example of the transmission and the gearwheels, it would also be possible to trace back to which manufacturing station installed which gearwheel into the transmission, and when, on the basis of the traceability of the transmission across all manufacturing steps, for example, also after the completion of the transmission.

This yields the advantage that, in the case of an identified product defect and, possibly, an identified product defect cause, inferences can be drawn, preferably, inferences can be drawn in an automated manner, regarding which product element has caused the product defect and at which manufacturing station the product defect arose. In the case of an accumulation of identical product defects and/or of identical product defect causes in a comparatively short time period, an appropriate lot of product elements can be sorted out, if necessary, or an appropriate manufacturing station can be inspected and serviced.

A manufacturing station is preferably designed for the semi-autonomous or fully autonomous execution of one or several manufacturing steps assigned thereto.

According to a further preferred example embodiment of the invention, an open-loop control of a manufacturing process of the product takes place under consideration of identified product defects and product defect causes. This yields the advantage that the identified product defects and also the identified product defect causes can be utilized for controlling, by way of an open-loop system, the manufacturing process in such a way that the identified product defects and the identified product defect causes can be avoided during the manufacture of further products. For example, a lot of product elements can be sorted out if the product elements result in an accumulation of product defects. A manufacturing station can also be inspected if the manufacturing steps that the manufacturing station carries out result in an accumulation of product defects. It is irrelevant whether the product defects in the latter case result from erroneously executed manufacturing steps of the relevant manufacturing station as the product defect cause or whether the product elements installed at the manufacturing station are defective and the product defect cause is therefore independent of the executed manufacturing step.

According to a further preferred example embodiment of the invention, acoustic items of information, mechanical items of information, and/or electrical items of information are gathered as the items of test information. This yields the advantage that an inspection is made possible that is preferably adapted to the particular product and, simultaneously, is as comprehensive as possible. Acoustic items of information are items of information regarding an acoustic behavior, e.g., a noise level, during a certain test run. For example, a product designed as a transmission for a vehicle can be operated at different rotational speeds in a predefined rotational speed range and, thereby, the acoustic behavior can be detected and analyzed in each case. This allows for a comparatively simple and fast, but nevertheless comprehensive inspection of the mechanical properties of the transmission as well, since, in particular, mechanical product defects are audible. A mechanical product defect cause, for example, a defective screw connection, can also be identified in this way. Electrical items of information can describe pure electrical conductivities and electrical resistances of the product as well as electronic items of diagnostic information, which are provided, for example, by a microcontroller of the product and can be read out within the scope of the inspection. Mechanical functions can be, for example, mechanical functionalities, such as carrying out gear changes in a product designed as a transmission, but also mechanical efficiencies, in order to identify products that are, in fact, functioning, in principle, but have an erroneously low efficiency.

According to a further preferred example embodiment of the invention, a repair measure as well as a probability of success and/or a cost and/or a time required for the repair measure of the product are/is determined on the basis of an identified product defect. Preferably, this also takes place in an automated manner. Either a decision can then be reached, in an automated manner, regarding the necessary repair measure under consideration of the associated probability of success, the cost, and/or the time requirement, or the appropriate items of information can be displayed to a human operator, who can then make an appropriate decision. Advantageously, an entry is stored in a database for each detected product defect regarding whether and, optionally, which type of repair measure is possible for eliminating the identified product defect. Under consideration of the items of information regarding the probability of success and/or the cost and/or the time required for the repair measure, which have advantageously also been stored in the database, a decision can then be reached regarding whether a repair or a repair attempt is to be carried out or whether this does not make economic sense and, therefore, the product must be disposed of. Provided that no appropriate database entries are present for a specific, identified product defect, a necessary repair measure as well as a probability of success, a cost, and a time required for the repair measure are preferably derived, in an automated manner, from available database entries regarding similar product defects.

In particular, it is preferred that the derived repair measure as well as the probability of success associated therewith, the cost, and the time required for the repair measure are verified or corrected within the scope of the actually executed repair. The verified or corrected items of information can then be advantageously incorporated into the database.

According to a further preferred example embodiment of the invention, the method is adapted, in an automated manner, to a multitude of products. This advantageously yields a broad usability of the method according to example aspects of the invention. Within the scope of the method, which product it is can be either detected in an automated manner, for example, or which product it is can also be manually entered by a human operator, for example. Thereafter, on the basis of the predefined or entered product, it can be determined, which items of test information are to be gathered by which test stands and with which groups of reference values the items of test information are to be compared on the basis of which distance matrix. The statistical process for the dimension reduction of the n-dimensional test value is also preferably selected in accordance with the particular product to be inspected, since each product can have different inspection-related priorities due to its different properties.

According to a further preferred example embodiment of the invention, a notification regarding identified product defects and/or product defect causes and/or the probability of success and/or cost and/or time required for the repair of the product is output in an automated manner. Preferably, the notification is output to a human operator, in particular to a supervisor of the production line that manufactures the product, or to a supervisor of the at least one test stand that tests the product. Additionally or alternatively, the notification can be output to a higher-order entity, for example, to a control division of a company, under the responsibility of which the product is manufactured and/or inspected.

Preferably, the notification is output in real time. Additionally, a summary and/or an overview of all notifications can be output in certain periods, for example, at the end of each day, at the end of each week, at the end of each month, and/or at the end of each year.

According to a further preferred example embodiment of the invention, the method is carried out by a knowledge-based artificial intelligence, wherein the artificial intelligence retrains itself. A knowledge-based artificial intelligence is a system, which can be advantageously utilized for delivering a response to a problem to be addressed or an issue that has arisen, which is formed on the basis of formalized expert knowledge and resultant, logical conclusions. For this purpose, the artificial intelligence preferably includes an extensive database, which contains, in particular, the multitude of reference values. Preferably, the artificial intelligence retrains itself, in that the artificial intelligence obtains items of information regarding the accuracy of the product defects and product defect causes the artificial intelligence has identified, and, possibly, regarding the probability of success, the cost, and/or the time required for the repair. These items of information fed back to the artificial intelligence are then advantageously stored, as reference values, by the artificial intelligence in the database and utilized for future inspections. As a result, an increasingly more reliable identification of all possible product defects and product defect causes takes place step by step.

According to a further preferred example embodiment of the invention, the method is carried out after the completion of the product. This yields the advantage that the completion of the product can be carried out quickly and, in particular, without interruptions for inspection processes. Instead, the method according to example aspects of the invention allows for a reliable inspection and identification of all possible product defects and product defect causes also after the completion of the product.

Example aspects of the invention also relate to a device for the automated identification of a product defect of a product and/or for the automated identification of a product defect cause of the product defect, including means
for producing the product from a multitude of product elements by a multitude of manufacturing steps, and
for gathering a number n of items of test information by at least one product test, wherein the n items of test information form an n-dimensional test value.

The device according to example aspects of the invention is distinguished by means
for carrying out a dimension reduction of the n-dimensional test value by at least one statistics process to obtain a dimension-reduced test value,
for comparing the dimension-reduced test value to a multitude of learned reference values,
for assigning the dimension-reduced test value to at least one group of reference values that are similar to each other, and
for identifying, in an automated manner, the product defect and/or the product defect cause on the basis of the assignment.

The device according to example aspects of the invention therefore advantageously includes all means necessary for carrying out the method according to example aspects of the invention.

Preferably, the device includes at least one manufacturing station, at which the product is manufactured from the multitude of product elements by the multitude of manufacturing steps. The at least one manufacturing station is preferably designed to be semi-autonomous or fully autonomous and is controlled, by an open-loop system, by the device via suitable software.

It is further preferred when the device includes at least one test stand, at which the n items of test information are gathered. The at least one test stand is preferably designed to be semi-autonomous or fully autonomous and is controlled, by an open-loop system, by the device via suitable software.

It is also preferred when the device also includes electronic compute(s)r, for example, in the form of a suitable microprocessor, working memory, and read-only memory, for carrying out the dimension reduction of the n-dimensional test value, for comparing the dimension-reduced test value, for assigning the dimension-reduced test value, and for the identification, in an automated manner, of the product defect and/or of the product defect cause according to suitably designed software algorithms.

Moreover, the device preferably also includes an output(s) for outputting notifications to human operators, for example, visual displays such as monitors and warning lights, acoustic output means such as loudspeakers, and a connection to a communication system such as, for example, an email system. Therefore, the device can output the notifications, for example, visually and acoustically, or send them via email. A connection of the device to a proprietary communication system is also conceivable, which makes it possible, for example, to send notifications similarly to an email system, but is operated exclusively on an internal network without a connection to the Internet.

According to one preferred example embodiment of the invention, the device is designed for carrying out the method according to example aspects of the invention. This yields the advantages already described in conjunction with the method according to example aspects of the invention.

### BRIEF DESCRIPTION OF THE DRAWINGS

Example aspects of invention are explained by way of example in the following with reference to embodiments represented in the figures, wherein

FIG. 1 shows, by way of example and diagrammatically, a manufacturing process of a product,

FIG. 2 shows, by way of example, a simplification achievable by the method according to the invention as compared to a comparison process that is typical from the prior art,

FIG. 3 shows, by way of example and diagrammatically, different variants of products and groups of reference values assigned thereto, in the form of a table,

FIG. 4 shows, by way of example and diagrammatically, several groups of reference values, and

FIG. 5 shows, by way of example, one possible embodiment of the method according to the invention for the automated identification of a product defect of a product and/or for the automated identification of a product defect cause of the product defect in the form of a flow chart.

Identical objects, functional units, and comparable components are marked with the same reference characters in all figures. These objects, functional units, and comparable components are identically designed with regard to their technical features, as long as nothing else results, explicitly or implicitly, from the description.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

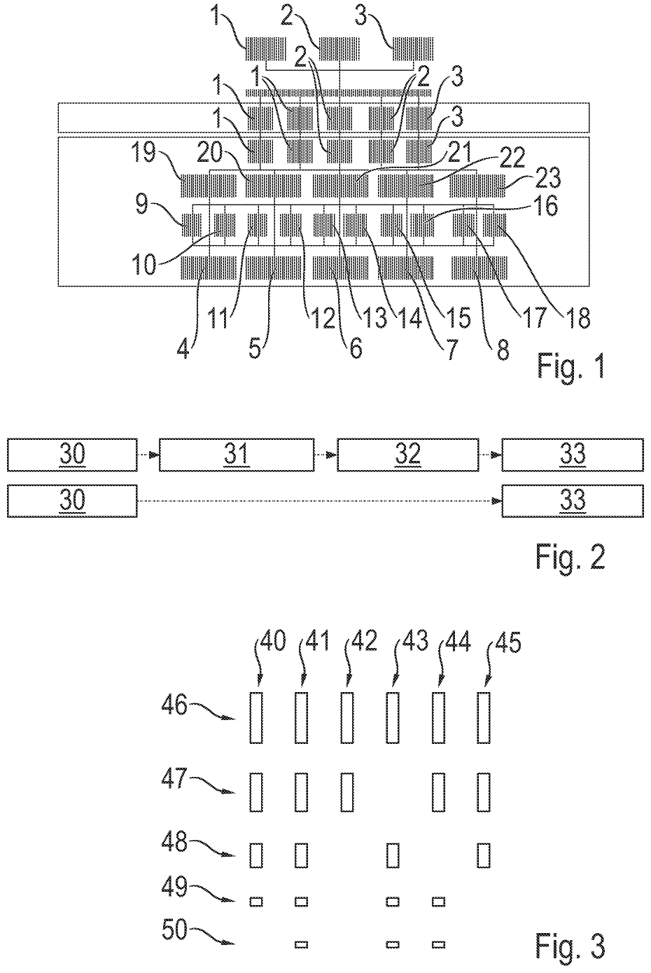

FIG. 1 shows, by way of example and diagrammatically, a manufacturing process of a product and the associated complexity of the identification of a product defect of the product and of the identification of the underlying product defect cause. Within the scope of the manufacturing process shown by way of example, three different variants 1, 2, 3 of a product 1, 2, 3 designed as a vehicle transmission 1, 2, 3 are manufactured, according to the example. The vehicle transmissions 1, 2, 3 are each manufactured from a multitude of product elements 4, 5, 6, 7, 8, 9, 10, 11, 12, 13, 14, 15, 16, 17, 18 in a multitude of manufacturing steps, wherein a first portion of product elements 4, 5, 6, 7, 8 is supplied and a second portion of product elements 9, 10, 11, 12, 13, 14, 15, 16, 17, 18 is manufactured in-house. The supplied product elements 4, 5, 6, 7, 8 as well as the in-house manufactured product elements 9, 10, 11, 12, 13, 14, 15, 16, 17, 18 can have a product defect. According to the example, the supplied product element 5 and the in-house manufactured product element 13 both have a product defect. The multitude of product elements 4, 5, 6, 7, 8, 9, 10, 11, 12, 13, 14, 15, 16, 17, 18 is assembled in one assembly step, a pre-assembly according to the example, to form assemblies 19, 20, 21, 22, 23. According to the example from FIG. 1, a product defect arises during the assembly of the assembly 20. The assemblies 19, 20, 21, 22, 23 are then combined, in a further assembly step, the final assembly according to the example, to form the complete products 1, 2, 3, namely the vehicle transmissions 1, 2, 3, wherein the vehicle transmissions 1 and 2 are produced, according to the example, in larger numbers than the vehicle transmission 3. A product defect also arises during the final assembly of the vehicle transmission 3, according to the example. After the final assembly, the vehicle transmissions 1, 2, 3 are inspected according to the method according to the invention for the automated identification of a product defect of a product and/or for the automated identification of a product defect cause of the product defect. The advantage of the method according to example aspects of the invention is, primarily, that only the fully assembled products 1, 2, 3, e.g., the vehicle transmissions 1, 2, 3, are inspected, and a series of individual inspections does not need to be carried out after each assembly step and/or after the delivery or the manufacture of the multitude of product elements 4, 5, 6, 7, 8, 9, 10, 11, 12, 13, 14, 15, 16, 17, 18. The method according to example aspects of the invention includes
producing the product 1, 2, 3 from a multitude of product elements 4, 5, 6, 7, 8, 9, 10, 11, 12, 13, 14, 15, 16, 17, 18 by a multitude of manufacturing steps, and
gathering a number n of items of test information by at least one product test, wherein the n items of test information form an n-dimensional test value,
carrying out a dimension reduction of the n-dimensional test value by at least one statistics process to obtain a dimension-reduced test value,
comparing the dimension-reduced test value to a multitude of learned reference values,
assigning the dimension-reduced test value to at least one group of reference values that are similar to each other, and
identifying, in an automated manner, the product defect and/or the product defect cause on the basis of the assignment.

Therefore, a reliable identification not only of the existing product defects, but also of the product defect causes underlying the product defects after the complete manufacture of the products 1, 2, 3 is made possible. According to the exemplary embodiment from FIG. 1, the vehicle transmissions 1, 2, 3 are subjected to an acoustic test, wherein a total of 170·10⁶ items of test information are gathered. By the statistics process, a dimension reduction of the 170·10⁶-dimensional test value to a dimension-reduced test value, namely, for example, a 1200-dimensional test value, is carried out. According to the example, it becomes apparent that one of the vehicle transmissions 1, both vehicle transmission 2, and the vehicle transmission 3 each have a product defect. Due to the method according to example aspects of the invention, it also becomes apparent that the product defect of the vehicle transmission 1 results from the faulty supplied product element 5 as the product defect cause. The product defects of the two vehicle transmissions 2 result from the faulty in-house manufactured product element 13 as well as from a faulty pre-assembly of the assembly 20, as the product defect cause. Finally, with respect to the product defect of the vehicle transmission 3, it becomes apparent that it results from a faulty final assembly of the vehicle transmission 3.

FIG. 2 shows, by way of example, a simplification achievable by the method according to example aspects of the invention as compared to a comparison process that is typical from the prior art, in the form of a flow chart. The known method is represented at the top in FIG. 2 and the method according to example aspects of the invention is represented at the bottom in FIG. 2. According to the prior art, in a method step 30, initially a product defect of a product 1, 2, 3 is identified. This also takes place within the scope of the method according to example aspects of the invention in step 30. In order to identify the product defect cause, the product is now disassembled, according to the prior art, by skilled persons in step 31 and, in step 32, the multitude of product elements 4, 5, 6, 7, 8, 9, 10, 11, 12, 13, 14, 15, 16, 17, 18 are individually examined and defects are analyzed, which is associated with a comparatively high time requirement and corresponding cost. The high time requirement results primarily from the fact that a multitude of individual tests must be carried out in order to identify the product defect cause. The product defect cause is first identified in step 33 as the result of the examination and analysis of the multitude of product elements 4, 5, 6, 7, 8, 9, 10, 11, 12, 13, 14, 15, 16, 17, 18. The method according to example aspects of the invention, however, allows for an automated identification not only of the product defect in step 30, but also of the product defect cause in step 33 by a comparison of the dimension-reduced test value with a multitude of groups of learned reference values. Due to the fact that the dimension-reduced test value is still characterized by all n items of test information, i.e., has similarities to appropriate groups of reference values, despite the dimension reduction by the at least one statistics process, the product defect cause can be finally identified by subsequently assigning the dimension-reduced test value to at least one group of reference values that are similar to each other. Therefore, significant savings of time and cost can be achieved as compared to the method that is typical from the prior art.

FIG. 3 shows, by way of example and diagrammatically, in the form of a table, different variants 40, 41, 42, 43, 44, 45 of products 40, 41, 42, 43, 44, 45 and, assigned thereto, groups of reference values 46, 47, 48, 49, 50, to which the test values are compared, in order to make an assignment possible. The groups of reference values 46, 47, 48, 49, 50 each describe different technical features and/or properties, some of which can be identical for several or all variants 40, 41, 42, 43, 44, 45 of products 40, 41, 42, 43, 44, 45. This identification of the particular variants 40, 41, 42, 43, 44, 45 to be inspected and of the groups of reference values 46, 47, 48, 49, 50 to be utilized takes place in an automated manner. Therefore, the method according to example aspects of the invention for the automated identification of a product defect of a product and/or for the automated identification of a product defect cause of the product defect can also be carried out in an easy way in the presence of different variants 40, 41, 42, 43, 44, 45 of products 40, 41, 42, 43, 44, 45.

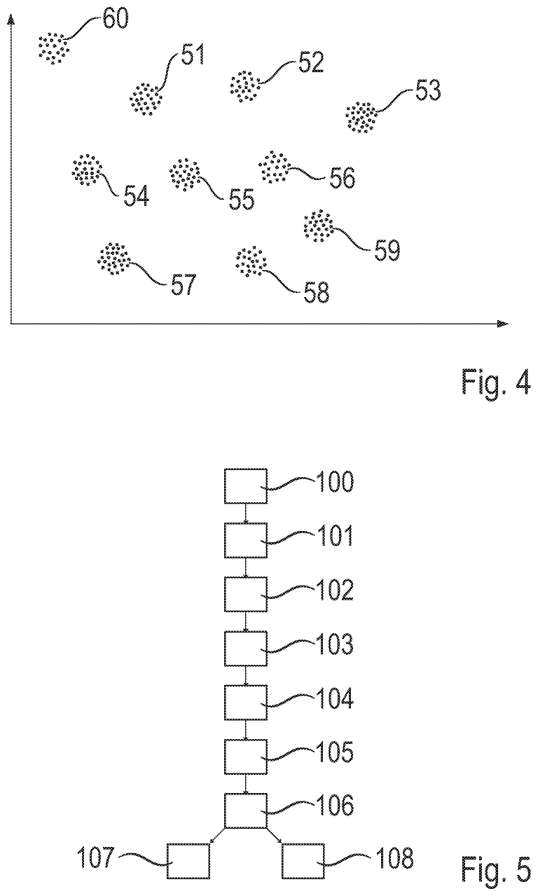

FIG. 4 shows, by way of example and diagrammatically, several groups 51, 52, 53, 54, 55, 56, 57, 58, 59, 60 of reference values, which were dimension-reduced to two dimensions in each case by at least one statistics process. The reference values are also characterized, in their two-dimensional representation, by all dimensions and/or items of test information taken into account in the at least one statistics process, which is why reference values that describe similar product properties and/or product defects are sorted into groups 51, 52, 53, 54, 55, 56, 57, 58, 59, 60. Neither the x-axis nor the y-axis has a unit, since the units are dispensed with anyway due to the dimension reduction. Similarities between the reference values and/or between the groups of reference values are represented exclusively by their particular spacing in the coordinate system. According to the example, the reference values of the group 51 represent a faulty clutch return mechanism of a product designed as a vehicle transmission. The product defect cause with respect to the reference values of the group 51 is a mechanical return spring that was inadvertently not installed during the assembly. If a test value that has also been reduced to two dimensions can now be assigned to the group 51 due to the proximity of the test value to this group 51, it can be detected, on the basis thereof, that the vehicle transmission, from which the test value originated, also has a faulty clutch return mechanism, in which the return spring was inadvertently not installed. The group 52 represents, according to the example, a fully operable and faultless transmission. The further groups 53, 54, 55, 56, 57, 58, 59, 60 each represent further specific product defects as well as the product defect causes underlying them.

FIG. 5 shows, by way of example, one possible example embodiment of the method according to the invention for the automated identification of a product defect of a product and/or for the automated identification of a product defect cause of the product defect in the form of a flow chart. In the method step 100, initially a production of the product 1, 2, 3, 40, 41, 42, 43, 44, 45 from a multitude of product elements 4, 5, 6, 7, 8, 9, 10, 11, 12, 13, 14, 15, 16, 17, 18 takes place by a multitude of manufacturing steps. In step 101, after a completion of the product 1, 2, 3, 40, 41, 42, 43, 44, 45, a gathering of a number n of items of test information takes place by at least one product test, wherein the n items of test information form an n-dimensional test value. Acoustic items of information, mechanical items of information, and electrical items of information are gathered as items of test information. In the following step 102, a dimension reduction of the n-dimensional test value is carried out by at least one statistics process to obtain a dimension-reduced test value, which, in step 103, is compared to a multitude of learned reference values 51, 52, 53, 54, 55, 56, 57, 58, 59, 60, wherein the reference values have a number of dimensions that is identical to that of the dimension-reduced test value. In the method step 104, an assignment of the dimension-reduced test value then takes place in accordance with a distance matrix to at least one group of reference values 51, 52, 53, 54, 55, 56, 57, 58, 59, 60 that are similar to each other, which, finally, in step 105, permits an identification of the product defect and, simultaneously in step 106, an identification of the product defect cause on the basis of the assignment. On the basis of the product defect and/or the product defect cause identified in step 106, an open-loop control of a manufacturing process of the product 1, 2, 3, 40, 41, 42, 43, 44, 45 takes place in the following step 107 in the sense that the manufacturing process is influenced, modified, and/or corrected in such a way that the identified product defect cause is avoided and the identified product defect therefore no longer arises in the subsequently manufactured products 1, 2, 3, 40, 41, 42, 43, 44, 45. Simultaneously with step 107, in step 108, a notification regarding the identified product defect, the product defect cause, the probability of success of a repair, the cost of the repair, and the time required for the repair of the product 1, 2, 3, 40, 41, 42, 43, 44, 45 is output, in an automated manner, to a group of human operators. According to the example, the method is carried out by a knowledge-based artificial intelligence, which retrains itself on the basis of the reference values fed thereto.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1, 2, 3 product, vehicle transmission
4, 5, 6, 7, 8, 9, 10 product element
11, 12, 13, 14, 15 product element
16, 17, 18 product element
19, 20, 21, 22, 23 assembly
30 identification of a product defect
31 identification of a product defect cause by skilled persons
32 examination and analysis of a multitude of product elements by skilled persons
33 identification of a defect cause
34 drive of the vehicle drive system additionally first electric motor
40, 41, 42 product, vehicle transmission
43, 44, 45 product, vehicle transmission
46, 47, 48, 49, 50 group of reference values
51, 52, 53, 54, 55 group of reference values
56, 57, 58, 59, 60 group of reference values
100 production of a product
101 gathering a number n of items of test information
102 carrying out a dimension reduction
103 comparison with a multitude of learned reference values
104 assigning the dimension-reduced test value to at least one group of reference values that are similar to each other
105 identifying the product defect
106 identifying the product defect cause
107 open-loop control of a manufacturing process
108 outputting a notification

1-15: (canceled)

16. A method for the automated identification of a product defect of a product (1, 2, 3, 40, 41, 42, 43, 44, 45) and/or for the automated identification of a product defect cause of the product defect, comprising:
producing the product (1, 2, 3, 40, 41, 42, 43, 44, 45) from a plurality of product elements (4, 5, 6, 7, 8, 9, 10, 11, 12, 13, 14, 15, 16, 17, 18) via a plurality of manufacturing steps;
gathering a number n of items of test information by at least one product test (101), the n items of test information forming an n-dimensional test value;
carrying out a dimension reduction of the n-dimensional test value (102) by at least one statistics process to obtain a dimension-reduced test value;
comparing the dimension-reduced test value (103) with a multitude of learned reference values (46, 47, 48, 49, 50, 51, 52, 53, 54, 55, 56, 57, 58, 59, 60);
assigning the dimension-reduced test value to at least one group of reference values (46, 47, 48, 49, 50, 51, 52, 53, 54, 55, 56, 57, 58, 59, 60, 104) that are similar to each other; and
identifying, in an automated manner, the product defect (105) and/or the product defect cause (106) on the basis of the assignment.

17. The method of claim 16, wherein the plurality of reference values (46, 47, 48, 49, 50, 51, 52, 53, 54, 55, 56, 57, 58, 59, 60) is classified according to product defects and/or product defect causes during a learning process.

18. The method of claim 16, wherein the assignment takes place (104) in accordance with a distance matrix.

19. The method of at least one of claim 16, wherein the reference values (46, 47, 48, 49, 50, 51, 52, 53, 54, 55, 56, 57, 58, 59, 60) are dimension-reduced by the at least one statistics process to a dimension number that is identical to that of the dimension-reduced test value.

20. The method of at least one of claim 16, wherein the dimension-reduced test value has at least one hundred dimensions.

21. The method of claim 16, wherein further comprising making available an assignability of the multitude of product elements (4, 5, 6, 7, 8, 9, 10, 11, 12, 13, 14, 15, 16, 17, 18) to the product (1, 2, 3, 40, 41, 42, 43, 44, 45) and/or a traceability of the product (1, 2, 3, 40, 41, 42, 43, 44, 45) across all manufacturing steps.

22. The method of claim 16, further comprising adjusting an open-loop control of a manufacturing process of the product (1, 2, 3, 40, 41, 42, 43, 44, 45) based at least in part on identified product defects and product defect causes (107).

23. The method of claim 16, wherein the items of test information comprises one or more of acoustic items of information, mechanical items of information, and electrical items of information.

24. The method of claim 16, wherein determining a repair measure as wells as one or more of a probability of success, a cost, and a time required for the repair measure of the product based at least in part on an identified product defect.

25. The method of claim 16, wherein further comprising adapting the method, in an automated manner, to a plurality of products (1, 2, 3, 40, 41, 42, 43, 44, 45).

26. The method of claim 16, wherein outputting one or more of a notification regarding identified product defects and/or product defect causes, the probability of success, cost, and time required for the repair of the product in an automated manner.

27. The method of claim 16, wherein the method is performed out by a knowledge-based artificial intelligence, wherein the artificial intelligence retrains itself.

28. The method of claim 16, wherein the method is carried out after completion of the product (1, 2, 3, 40, 41, 42, 43, 44, 45).

29. A device for automated identification of a product defect of a product (1, 2, 3, 40, 41, 42, 43, 44, 45) and/or for the automated identification of a product defect cause of the product defect, comprising:
means for producing the product (1, 2, 3, 40, 41, 42, 43, 44, 45) from a plurality of product elements (4, 5, 6, 7, 8, 9, 10, 11, 12, 13, 14, 15, 16, 17, 18) by a plurality of manufacturing steps;
means for gathering a number n of items of test information by at least one product test, the n items of test information forming an n-dimensional test value;
means for carrying out a dimension reduction of the n-dimensional test value by at least one statistics process to obtain a dimension-reduced test value;
means for comparing the dimension-reduced test value with a multitude of learned reference values (46, 47, 48, 49, 50, 51, 52, 53, 54, 55, 56, 57, 58, 59, 60);
means for assigning the dimension-reduced test value to at least one group of reference values (46, 47, 48, 49, 50, 51, 52, 53, 54, 55, 56, 57, 58, 59, 60, 104) that are similar to each other; and
means for identifying, in an automated manner, the product defect and/or the product defect cause based on the assignment.

30. A device configured for implementing the method of claim 16.
